(19) United States
(12) Patent Application Publication
(10) Pub. No.: US 2019/0104790 A1
(43) Pub. Date: Apr. 11, 2019

(54) REINFORCEMENT FIBER FOR PROTECTION PRODUCTS

(71) Applicant: KAI-HSI TSENG, Changhua County (TW)

(72) Inventor: KAI-HSI TSENG, Changhua County (TW)

(21) Appl. No.: 15/730,557

(22) Filed: Oct. 11, 2017

(51) Int. Cl. A41D 31/00; B32B 5/26; B32B 5/12

(52) U.S. Cl. CPC A41D 31/005; A41D 31/0061; F41H 5/0485; B32B 5/12; B32B 5/26

(57) ABSTRACT

Provided is a reinforcement fiber for a protection product. The reinforcement fiber includes multiple adjacent filaments, each filament is composed of a core and a shell formed around the core, and a melting temperature of the shell is lower than a melting temperature of the core, the shell of each filament attached to the shell of the adjacent filament. The reinforcement fiber can be manufactured into a protection product with good impact resistance simply through heating and molding.

### BACKGROUND OF THE INVENTION

### 1. Field of the Invention

The present invention relates to a reinforcement fiber for protection products.

### 2. Description of the Prior Arts

Since objects are often damaged due to an external force either in use or during transport, and athletes are often injured due to an external force in training or competitions, the prior arts provide a variety of protection products, such as luggage and protective gears, for people to choose according to demand.

In the preparation of the protection products in the prior arts, a single material (e.g., polypropylene) is first made into a sheet. Multiple sheets are woven into a woven fabric, and then multiple woven fabrics are laminated and molded to obtain the protection products. However, the protection products made of a single material only have quite limited impact resistance. When the protection products in the prior arts are subjected to a large external force, they will be broken and lose their protective function, thereby causing the damage to the objects and the injury of the athletes.

In order to improve the impact resistance of the conventional protection products, a conventional solution places a reinforcing film between two adjacent woven fabrics, and then processes molding to obtain another conventional protection product. However, the use of the reinforcing film increases the process complexity and production cost.

### SUMMARY OF THE INVENTION

An objective of the present invention is to provide a reinforcement fiber for protection products. A reinforcement fabric woven from the reinforcement fiber can be simply molded into a protection product with good impact resistance, thereby reducing the process complexity and production cost of the protection products.

To achieve the foresaid objective, the present invention provides a reinforcement fiber for protection products. The reinforcement fiber comprises multiple filaments, each filament composed of a core and a shell formed around the core. A melting temperature of the shell is lower than a melting temperature of the core. The shell of each filament is attached to the shell of the adjacent filament.

The core is made of polypropylene copolymers or polypropylene homopolymers, and the shell is made of polyethylene copolymers, polyethylene homopolymers, polypropylene copolymers or polypropylene homopolymers.

The melting temperature of the core is between 160° C. and 180° C. and the melting temperature of the shell is between 120° C. and 150° C.

Based on the above technical means, the reinforcement fabrics woven from the foresaid reinforcement fiber can be manufactured into protection products with good impact resistance simply through heating and molding without using any reinforcing film. Therefore, the reinforcement fiber has the advantages of both manufacturing protection products with good impact resistance and reducing the process complexity and production cost.

The invention will become more apparent from the following detailed description when taken in conjunction with the accompanying drawings and embodiment, rather than limiting the scope of the invention.

### BRIEF DESCRIPTION OF THE DRAWINGS

FIG. 1 is a sectional view of a reinforcement fiber for protection products of the present invention;

FIG. 2 is a sectional view of a filament of the reinforcement fiber for protection products of the present invention;

FIG. 3 is a side cross-sectional view of a reinforcement fabric woven from the reinforcement fiber for protection products of the present invention;

FIG. 4 is a side cross-sectional view of a protection product made by the reinforcement fabric, which is woven from the reinforcement fiber of the present invention;

FIG. 5 is a partial enlarged view of FIG. 4;

FIG. 6 is a side cross-sectional view of another protection product made by the reinforcement fabric, which is woven from the reinforcement fiber of the present invention; and

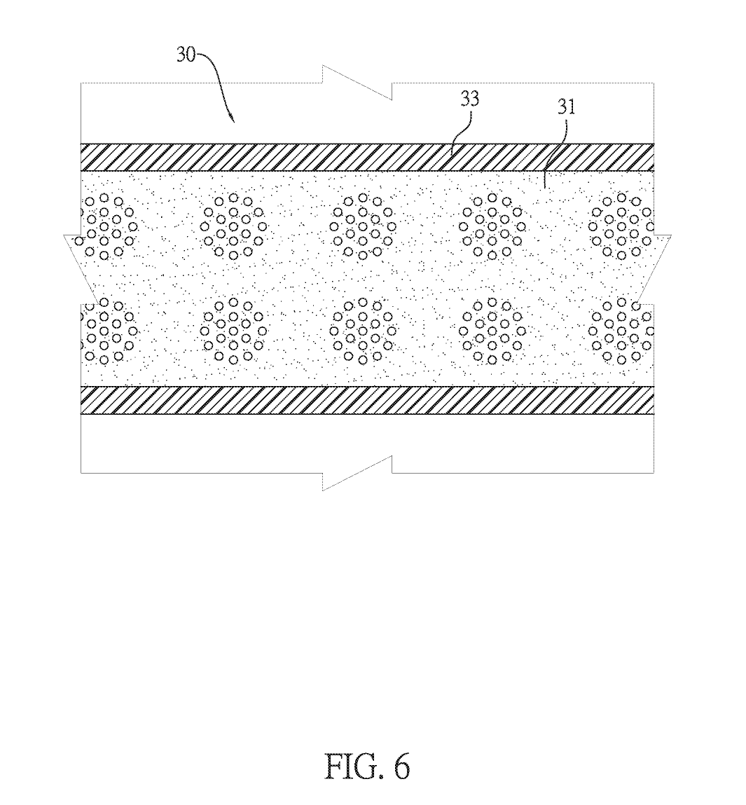

FIG. 7 is a flow chart of manufacturing protection products by the reinforcement fiber of the present invention.

### DETAILED DESCRIPTION OF THE PREFERRED EMBODIMENTS

In order to illustrate the technical means adopted by the present invention to achieve the objective, the preferred embodiments of the present invention will be further described in detail below with reference to the drawings.

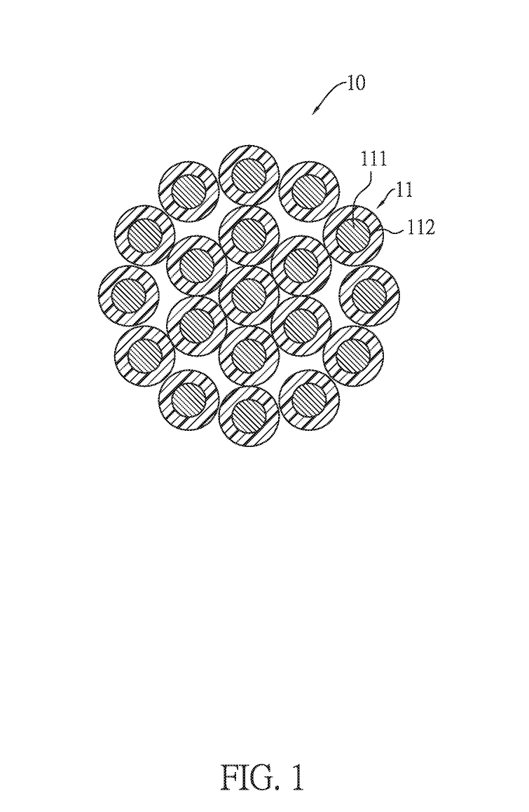

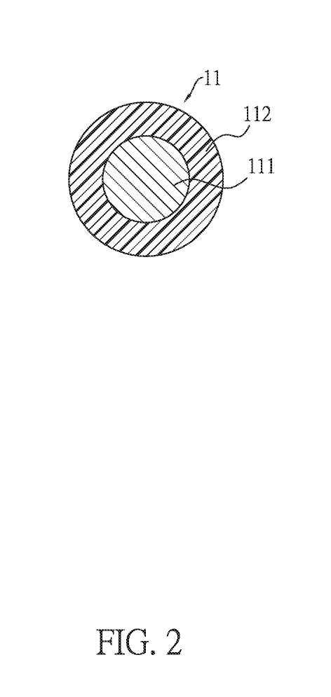

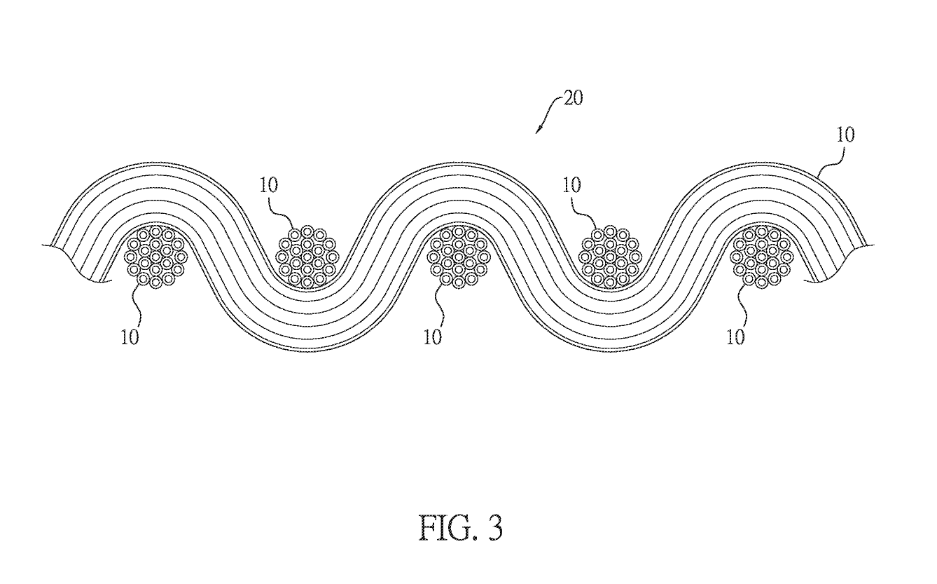

As illustrated in FIG. 1 to FIG. 3, a reinforcement fiber 10 for protection products of the present invention is composed of multiple adjacent filaments 11, which are gathered into bundles. In other words, each reinforcement fiber 10 is a single bundle of filaments 11. Each filament 11 is a round bar and composed of a core 111 and a shell 112. The core 111 is a round bar and the shell 112 is formed around the core 111, and a melting temperature of the shell 112 is lower than a melting temperature of the core 111. The shell 112 of each filament 11 is attached to the shell 112 of an adjacent filament. In addition, each reinforcement fiber 10 is substantially a round bar.

In a preferred embodiment, the core 111 is made of polypropylene copolymers or polypropylene homopolymers, while the shell 112 is made of polyethylene copolymers, polyethylene homopolymers, polypropylene copolymers or polypropylene homopolymers. More specifically, the melting temperature of the polyethylene copolymer, polyethylene homopolymer, polypropylene copolymer, and polypropylene homopolymer for the shell 112 is lower than the melting temperature of the polypropylene copolymer and polypropylene homopolymer for the core 111. In other words, the polyethylene copolymer, polyethylene homopolymer, polypropylene copolymer and polypropylene homopolymer for the shell 112 are low-melting point polyethylene copolymer, low-melting point polyethylene homopolymer, low-melting point polypropylene copolymer and low-melting point polypropylene homopolymer respectively, while the polypropylene copolymer and polypropylene homopolymer for the core 111 are high-melting point polypropylene copolymer and high-melting point polypropylene homopolymer respectively. In a preferred embodiment, the melting temperature of the core 111 is between 160° C. and 180° C. and the melting temperature of the shell 112 is between 120° C. and 140° C.

As illustrated in FIG. 1 to FIG. 3, multiple reinforcement fibers 10 are woven to a reinforcement fabric 20. In a preferred embodiment, the reinforcement fabric 20 is woven from the reinforcement fibers 10 and multiple reinforcing fibers. The materials of the reinforcing fibers are different from those of the reinforcement fibers 10. The reinforcing fibers may be aramid fibers.

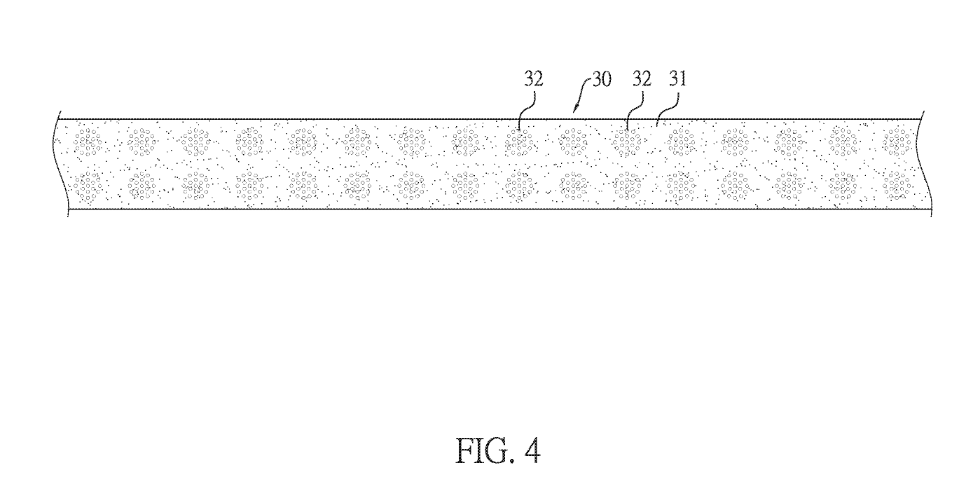

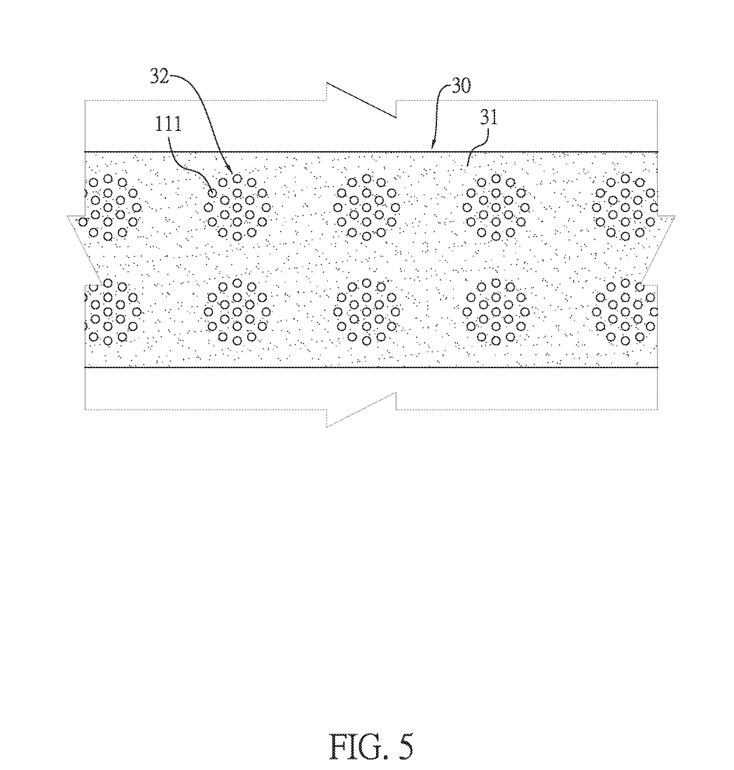

As illustrated in FIG. 4 and FIG. 5, the reinforcement fabric 20 can be made into a protection product 30. The protection product 30 comprises a base 31 and multiple reinforced portions 32. The base 31 is constructed by the shell 112 of the filaments 11, and the reinforced portions 32 are arranged at spaced intervals in the base 31, and the reinforced portions 32 comprise multiple cores 111, the melting point of each core 111 being higher than the melting point of the base 31. In a preferred embodiment, the thickness of the protection product 30 is 0.3 mm to 2 mm. In a preferred embodiment, the protection product 30 also comprises a decoration layer 33 bonded to the surface of the base 31, and the decoration layer 33 is made of polyethylene, polypropylene, poly(ethylene terephthalate), polystyrene or polyethylene terephthalate.

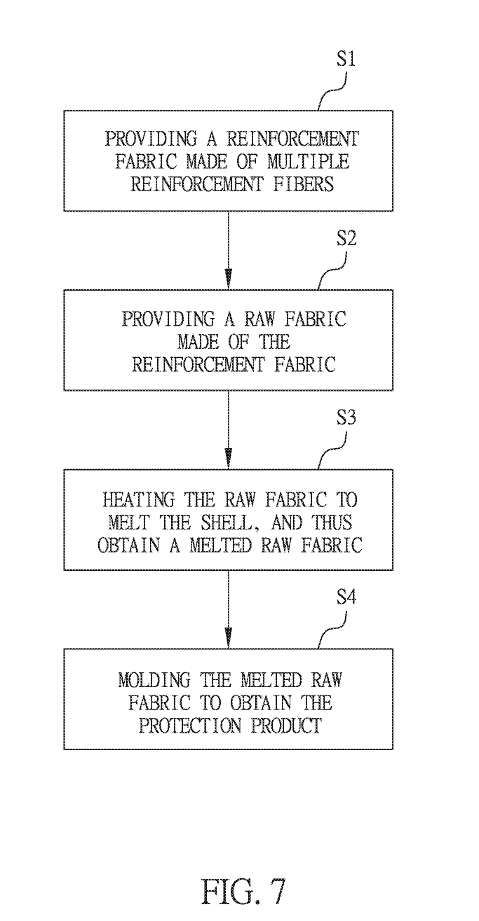

As illustrated in FIG. 7, the method for manufacturing the protection product from the reinforcement fibers comprises: a step S1 of providing a reinforcement fabric 20 made of multiple reinforcement fibers 10; a step S2 of providing a raw fabric made of the reinforcement fabric 20; a step S3 of heating the raw fabric to melt the shell 112, and thus obtaining a melted raw fabric; and a step S4 of molding the melted raw fabric to obtain the protection product. In a preferred embodiment, the raw fabric is a reinforcement fabric 20. In another preferred embodiment, the raw fabric is formed by laminating multiple reinforcement fabrics 20 as stated above.

### PREPARATION EXAMPLE 1

### Preparation of Protection Product 30

Multiple reinforcement fibers 10 were woven to obtain a reinforcement fabric 20. Multiple reinforcement fabrics 20 were laminated to obtain a raw fabric. Thereafter, the raw fabric was heated by infrared rays at a heating temperature of 155° C. for 3 minutes, in order to melt the shell 112 of the filament 11 of the reinforcement fiber 10 to obtain a melted raw fabric. Subsequently, the melted raw fabric was put into a mold at room temperature and pressed under a pressure of 6 MPa for 1 minute by a press machine, and then released from the mold to obtain the protection product 30.

In the present preparation example, the melting temperature of the shell 112 of the filament 11 in each reinforcement fiber 10 was 150° C., the melting temperature of the core 111 of the filament 11 in each reinforcement fiber 10 was 170° C., and the thickness of the protection product 30 was 1 mm.

### PREPARATION EXAMPLE 2

### Preparation of Protection Product 30

The preparation of the protection product in the present preparation example was similar to the preparation of the protection product 30 in Preparation Example 1, except that the raw fabric was heated by a halogen lamp to obtain a melted raw fabric in the present preparation example.

### PREPARATION EXAMPLE 3

### Preparation of Protection Product 30

Multiple reinforcement fibers 10 were woven to obtain a reinforcement fabric 20. Multiple reinforcement fabrics 20 are laminated to obtain a raw fabric. Thereafter, the raw fabric was placed in a mold at a heating temperature of 155° C. for 1 minute, in order to melt the shell 112 of the filament 11 of the reinforcement fiber 10 to obtain a melted raw fabric. Subsequently, the melted raw fabric was put into a mold at room temperature and pressed at a pressure of 6 MPa for 30 seconds to 40 seconds by a press machine, and then released from the mold to obtain the protection product 30.

In the present preparation example, the melting temperature of the shell 112 of the filament 11 in each reinforcement fiber 10 was 150° C., the melting temperature of the core 111 of the filament 11 in each reinforcement fiber 10 was 170° C., and the thickness of the protection product 30 was 0.6 mm.

As can been seen from above, the reinforcement fiber 10 is composed of multiple filaments 11 and the melting temperature of the shell 112 of each filament 11 is lower than the melting temperature of the core 111 of each filament 11, so the reinforcement fiber 10 can be directly heated to melt the shell 112 of each filament 11 while the core 111 of each filament 11 is not melted, and then molded to be the protection product 30, wherein the shell 112 of the filaments 11 in the reinforcement fiber 10 is melted and bonded to a base 31 solidified into the protection product 30, and the base 31 of the protection product 30 tightly coats the core 111 of the filaments 11 in the reinforcement fiber 10. Because the core 111 of each filament 11 is not melted during the process of manufacturing the protection product 30, the strength of the core 111 of each filament 11 is not weakened, so as to enhance the overall structural strength of the protection product 30.

Therefore, the reinforcement fabric 20 woven from the reinforcement fiber 10 can be manufactured into a protection product 30 with good impact resistance simply through heating and molding without a reinforcing film, thereby reducing the process complexity and cost of the protection product 30.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

1. A reinforcement fiber for protection products, consisting of:
multiple filaments, each filament composed of a core and a shell formed around the core, and a melting temperature of the shell being lower than a melting temperature of the core, the shell of each filament attached to and in contact with the shell of the adjacent filament;
wherein the core is made of polypropylene copolymers, and the shell is made of polypropylene copolymers;
wherein the melting temperature of the core is between 170° C. and 180° C. and the melting temperature of the shell is between 140° C. and 150° C.

2. (canceled)

3. (canceled)

4. (canceled)
